(19) United States
(12) Patent Application Publication
(10) Pub. No.: US 2025/0351999 A1
(43) Pub. Date: Nov. 20, 2025

(54) Cooking Utensil For A Food Preparation Appliance

(71) Applicant: SEB S.A., Ecully (FR)

(72) Inventors: Gautier Fradet, Ecully Cedex (FR); Marie Dussart, Ecully Cedex (FR); Johann Petitallot, Ecully Cedex (FR); Guillaume Prieto, Ecully Cedex (FR); Frédéric Denis Seurat, Ecully Cedex (FR)

(73) Assignee: SEB S.A., Ecully (FR)

(21) Appl. No.: 19/210,683

(22) Filed: May 16, 2025

(30) Foreign Application Priority Data
May 17, 2024 (FR) FR2405122

(51) Int. Cl. A47J 37/06

(52) U.S. Cl. CPC A47J 37/0641

(57) ABSTRACT

A cooking utensil for a food preparation appliance includes
a cooking vat,
a gripping interface configured to be reversibly attached to the cooking vat,
and an attachment mechanism. The attachment mechanism includes at least
an upper vat protrusion
and an upper gripping protrusion.

The upper vat protrusion and the upper gripping protrusion are configured to be moved
to release the upper gripping protrusion including a downwardly-directed uncoupling motion, and/or
moved to couple the upper gripping protrusion including a coupling motion directed towards a top of the cooking vat.

### TECHNICAL FIELD OF THE INVENTION

The present invention generally relates to a cooking utensil for a food preparation appliance. In particular, the invention relates to a cooking utensil comprising a cooking vat that can be held in a cooking space of a food preparation appliance, and comprising gripping means provided to make it easier to handle the cooking vat.

### STATE OF THE ART

Food preparation appliances in the prior art commonly feature a cooking vat that can be removed from the food preparation appliance and is equipped with a gripping interface. Such a gripping interface can be designed to be removable relative to the cooking vat, for example to make cleaning easier. On the other hand, this system can have drawbacks related to user safety. Indeed, it is important to prevent any risk of inadvertent release between the cooking vat and the gripping interface, particularly if the cooking vat has just been removed from the food preparation appliance and contains hot food. However, simple, ergonomic operation must also be provided so that the cooking vat can be quickly released from the gripping interface, thereby avoiding any adverse effects on or complications for the user experience.

### DISCLOSURE OF THE INVENTION

One purpose of the present invention is to address the aforementioned drawbacks of the prior art and, more specifically, first of all, to provide a cooking utensil comprising a cooking vat and a gripping interface that can be removed from the cooking vat and which can be safely used as it prevents any inadvertent release between the cooking vat and the gripping interface while also providing simple, ergonomic operation for quickly releasing the cooking vat from the gripping interface.

To this end, a first aspect of the invention relates to a cooking utensil for a food preparation appliance, comprising at least:
a cooking vat, designed to hold food to be prepared and designed to be held in an inner cooking space of the food preparation appliance,
a gripping interface, designed to be reversibly attached to the cooking vat,
an attachment mechanism, comprising at least:
an upper vat attachment, mounted on the cooking vat and arranged on an upper part of the cooking vat,
an upper gripping attachment, mounted on the gripping interface and designed to reversibly couple with the upper vat attachment,
characterized in that the upper vat attachment and the upper gripping attachment are designed to impose:
a movement to release the upper gripping attachment having an uncoupling motion component directed towards the bottom of the cooking vat, and/or
a movement to couple the upper gripping attachment having a coupling motion component directed towards the top of the cooking vat.

The cooking utensil comprises an attachment mechanism with an upper vat attachment and an upper gripping attachment which are designed to impose a movement to release the upper gripping attachment having an uncoupling motion component directed towards the bottom of the cooking vat and/or a movement to couple the upper gripping attachment having a coupling motion component directed towards the top of the cooking vat. As a result, the upper gripping attachment must be moved relatively downward relative to the cooking vat to release it, so that when the user handles the cooking utensil (cooking vat and gripping interface coupled together), the weight of the cooking vat and the food contained therein prevents any inadvertent release movement. In other words, the upper gripping attachment is designed to bear the weight of the cooking vat via the upper vat attachment. To release the cooking vat from the gripping interface, a specific action must be taken to bear the weight of the cooking vat: either by setting the vat on a supporting surface or by holding the cooking vat directly, and then pulling/moving the gripping interface downwards.

According to the above embodiment, the upper gripping attachment is designed to support the upper vat attachment (and therefore the cooking vat), and in particular, the upper gripping attachment is designed to hold the vat in the air solely by the interaction of the upper gripping attachment on the upper vat attachment.

According to one embodiment, the upper vat attachment and the upper gripping attachment are designed to form, when coupled, a pivot connection between the cooking vat and the gripping interface. In other words, when only the upper gripping attachment and the upper vat attachment are coupled, the gripping interface can pivot relative to the cooking vat.

According to one embodiment, the attachment mechanism comprises:
a lower vat attachment, mounted on the cooking vat and arranged on a lower part of the cooking vat,
a lower gripping attachment, mounted on the gripping interface and designed to reversibly couple with the lower vat attachment.

According to one embodiment, the lower vat attachment and the lower gripping attachment are designed to block a degree of rotational freedom, and preferably a degree of translational freedom, between the cooking vat and the gripping interface, once the upper vat attachment and the upper gripping attachment are coupled.

According to one embodiment:
one of the upper vat attachment and of the upper gripping attachment comprises a holding shape such as a hook, an orifice, or a U-shape,
the other of the upper vat attachment and of the upper gripping attachment comprises a male shape such as a wire, a rod, a lip, or a finger, designed to be received in the holding shape.

According to one embodiment:
the upper vat attachment and the upper gripping attachment are designed to couple in a first coupling phase between the cooking vat and the gripping interface,
the lower vat attachment and the lower gripping attachment are designed to couple in a second coupling phase between the cooking vat and the gripping interface. In other words, the coupling between the cooking vat and the gripping interface is sequential: first the upper vat attachment and the upper gripping attachment are coupled, then the lower vat attachment and the lower gripping attachment are coupled.

According to one embodiment:
the lower vat attachment and the lower gripping attachment are designed to uncouple in a first release phase between the cooking vat and the gripping interface,
the upper vat attachment and the upper gripping attachment are designed to uncouple in a second release phase between the cooking vat and the gripping interface. In other words, the uncoupling between the cooking vat and the gripping interface is sequential: first the lower vat attachment and the lower gripping attachment are released, then the upper vat attachment and the upper gripping attachment are released.

According to one embodiment, the attachment mechanism comprises a locking mechanism designed to reversibly lock the gripping interface to the cooking vat. Preferably, the locking mechanism is designed to (reversibly) lock the gripping interface to the cooking vat once the upper vat attachment and the upper gripping attachment are coupled.

According to one embodiment:
one of the lower vat attachment and of the lower gripping attachment comprises a movable locking member such as a hook, an orifice, a U-shape,
the other of the lower vat attachment and of the lower gripping attachment comprises a locking counter-form such as a wire, a rod, a lip, a finger, and designed to be locked by the movable locking member. In other words, the locking mechanism is designed to block and lock the lower vat attachment with the lower gripping attachment, for example when they are coupled together.

According to one embodiment, the lower vat attachment and the lower gripping attachment are designed to impose:
a movement to release the upper gripping attachment having an uncoupling motion component directed towards the bottom of the cooking vat,
a movement to couple the upper gripping attachment having a coupling motion component directed towards the top of the cooking vat.

According to one embodiment, the movable locking member is designed such that it latches the attachment of the gripping interface to the cooking vat when the cooking vat is inserted into the inner cooking space of the food preparation appliance.

According to one embodiment:
one of the lower vat attachment and of the lower gripping attachment comprises a holding shape such as a hook, an orifice, a U-shape,
the other of the lower vat attachment and of the lower gripping attachment comprises a male shape such as a wire, a rod, a lip, a finger, and designed to be received in the holding shape.

According to one embodiment, the locking mechanism is designed to lock a lower part of the cooking vat to the gripping interface and/or to thus block a release movement between the lower attachment of the vat and the lower attachment of the gripping device.

According to one embodiment, the locking mechanism comprises:
a movable locking member, such as a lock or a hook,
a control member, such as a push button, connected to the locking member and designed to be manually controlled by a user.

According to one embodiment, the cooking utensil comprises a coupling detection device, comprising at least one coupling indicator which can be moved between:
a resting position, occupied when the cooking vat is uncoupled from the gripping interface,
an activated position, occupied when the cooking vat is coupled with the gripping interface. The coupling indicator makes it easy to check whether or not the cooking vat and the gripping interface are actually coupled.

According to one embodiment, the coupling indicator:
is arranged on one of the cooking vat and of the gripping interface,
is designed to be moved to the activated position by the other of the cooking vat and of the gripping interface. The coupling indicator, provided on one of the cooking vat and of the gripping interface, is moved to the activated position by the other of the cooking vat and of the gripping interface. Thus, movement to the activated position only takes place when the coupling is engaged.

According to one embodiment, the coupling detection device comprises an elastic return member designed to exert a return force on the coupling indicator towards the resting position. The coupling indicator is automatically (and continuously) returned to the resting position: as soon as the coupling between the cooking vat and the gripping interface is released, the coupling indicator leaves the activated position and is pushed back or moved to the resting position.

According to one embodiment, the coupling indicator is arranged on the gripping interface, and the coupling detection device comprises a transmission member such as a rocker arm, comprising:
an input portion, designed to be actuated by the upper vat attachment at least during an operation in which the gripping interface is coupled to the cooking vat,
an output portion, engaged with or in contact with the coupling indicator. Such a rocker arm mechanism is simple to manufacture and robust in operation.

According to one embodiment, the gripping interface comprises a wall portion such as a front panel of the food preparation appliance.

According to one embodiment, the cooking utensil comprises:
a vat lid designed to cover or close the cooking vat,
means for closing the lid designed to interact with the upper vat attachment. The user can then release the cooking vat from the gripping interface and cover the cooking vat with a lid that can itself be coupled to the upper vat attachment.

A second aspect of the invention relates to a food preparation appliance comprising:
a cooking utensil according to the first aspect,
a housing forming a cooking space for holding the cooking vat of the cooking utensil,
cooking means.

According to one embodiment, the housing has an opening which is intended to be closed by the wall portion (front panel) of the cooking utensil, the wall portion being designed to be continuous with the surface of the housing of the food preparation appliance. Thus, access to the cooking space of the food preparation appliance is blocked by the cooking utensil (by the portion of the wall forming a front panel).

According to one embodiment, the food preparation appliance comprises the cooking utensil as described above and a safety system comprising a sensor for detecting the coupling indicator at least in the activated position, and designed to allow the cooking means to operate only if the coupling indicator is detected in the activated position. In other words, if the cooking vat is installed in the food preparation appliance with no gripping interface (and therefore with no wall portion forming the front panel), the food preparation appliance will not start and/or will not be able to operate.

### DESCRIPTION OF THE FIGURES

Other features and advantages of the present invention will become more apparent from the following detailed description of one or more embodiment(s) of the invention, provided by way of one or more non-limiting example(s) and illustrated in the appended figures, in which:

FIG. 1 shows a perspective view of a food preparation appliance comprising, in particular, a housing and a cooking utensil;

FIG. 2 shows a perspective view of the cooking utensil in FIG. 1, comprising a cooking vat and a gripping interface coupled together;

FIG. 3 shows a perspective view of the cooking utensil in FIG. 2 with the cooking vat and gripping interface uncoupled;

FIG. 4 shows a perspective side view of the gripping interface of the cooking utensil in FIG. 2 or 3;

FIG. 5 shows a perspective rear view of the gripping interface of the cooking utensil in FIG. 2 or 3;

FIG. 6 shows a perspective top view of the cooking vat of the cooking utensil in FIG. 2 or 3;

FIG. 7 shows a cross-sectional view of the cooking utensil in FIG. 2 in a plane parallel to the y-z plane of the reference point in FIG. 2;

FIG. 8 shows a rear view of an inner part of the gripping interface of the cooking utensil in FIG. 2 or 3;

FIG. 9 shows a cross-sectional view of the inner part of the gripping interface in FIG. 8 in a cross-sectional plane II-II of FIG. 8;

FIG. 10 shows a cross-sectional view of the gripping interface of the cooking utensil in FIG. 8 in a cross-sectional plane I-I of FIG. 8 and part of the housing of the food preparation appliance;

FIG. 11 shows a perspective top view of the cooking vat of the cooking utensil in FIG. 2 or 3; with a lid to be coupled to the cooking vat;

FIG. 12 shows a perspective top view of the cooking vat of the cooking utensil in FIG. 2 or 3; with the lid coupled to the cooking vat;

FIG. 13 shows a schematic cross-sectional view, in a plane parallel to the y-z plane of the reference point in FIG. 2, of the cooking vat and of the gripping interface of the cooking utensil in FIG. 2 or 3, before coupling;

FIG. 14 shows the cooking vat and the gripping interface in FIG. 13 in a first coupling phase;

FIG. 15 shows the cooking vat and the gripping interface in FIG. 13 in a second coupling phase;

FIG. 16 shows the cooking vat and the gripping interface in FIG. 13, coupled together;

FIG. 17 shows a first variant embodiment of the cooking vat and of the gripping interface in FIG. 13;

FIG. 18 shows a second variant embodiment of the cooking vat and of the gripping interface in FIG. 13;

FIG. 19 shows a third variant embodiment of the cooking vat and of the gripping interface in FIG. 13.

### DETAILED DESCRIPTION OF EMBODIMENT(S)

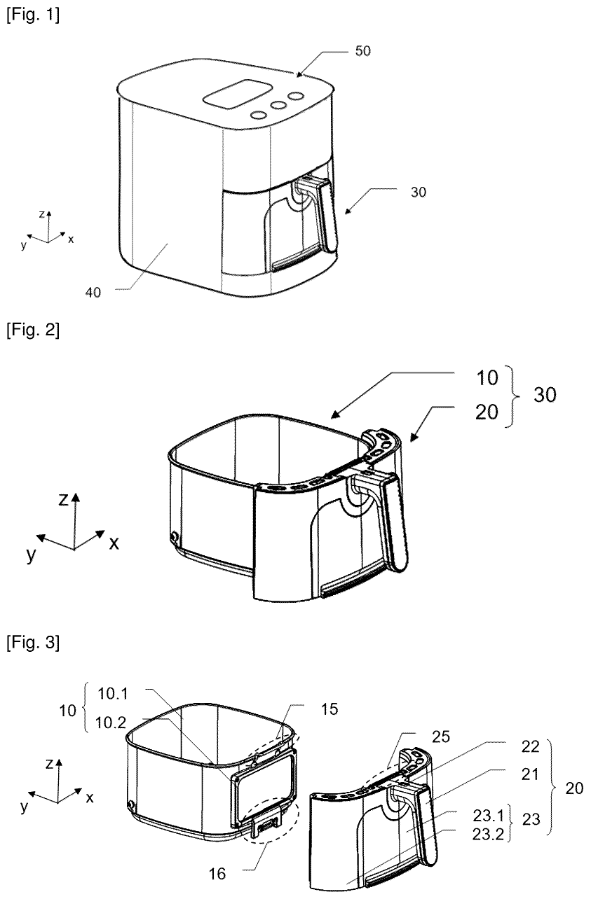

FIG. 1 shows a perspective view of a food preparation appliance, which in this example is a food preparation appliance and comprises in particular:
a housing 40,
a cooking utensil 30,
a human-machine interface 50.

In the example in FIG. 1, the food preparation appliance is a household cooking appliance designed to cook food by radiation and/or convection. Cooking means, which are typically heating means and/or ventilation means, can therefore be provided in the housing 40. Heating means can comprise Joule heating means (one or more resistive heating elements), and ventilation means can comprise a ventilation member such as a motorized fan. However, conduction, induction, or even microwave heating means can also be provided.

The food preparation appliance in FIG. 1 typically comprises at least one electronic control unit and/or means for storing instructions or commands, and the human-machine interface 50 enables a user to select recipes, operating instructions, and to control and/or operate the food preparation appliance. The human-machine interface 50 can typically comprise a display and/or a touch screen, and control buttons.

The housing 40 forms an outer frame of the food preparation appliance, and the cooking utensil 30 comprises a wall portion that forms a front panel of the food preparation appliance, which extends the housing 40 (the surfaces are continuous and extend or are continuous with each other as can be seen in FIG. 1).

FIG. 1 shows a Cartesian coordinate system x/y/z, which is used to define, in particular, a width of the appliance along the x-axis, a depth of the appliance along the y-axis, and a height of the appliance along the z-axis. It can be seen in FIG. 1 that the human-machine interface 50 is arranged on top of the food preparation appliance, but it could be arranged on a side wall, on the front panel, or even (partially) offset on a portable electronic device.

FIG. 2 shows a perspective view of the cooking utensil 30 in FIG. 1, comprising a cooking vat 10 and a gripping interface 20 coupled together. In this exemplary embodiment, the cooking utensil 30 comprises a cooking vat 10 designed to hold food to be cooked and to be positioned in an inner cooking space formed inside the housing 40. Typically, when the cooking utensil 30 is held in the food preparation appliance as shown in FIG. 1, the cooking vat 10 positions the food held therein opposite the heating means and/or opposite the ventilation means.

In FIG. 2, the cooking vat 10 is coupled to the gripping interface 20 to form an assembly that is easy for a user to grasp and handle.

FIG. 3 shows a perspective view of the cooking utensil 30 in FIG. 2 with the cooking vat 10 and gripping interface 20 uncoupled and separated from each other.

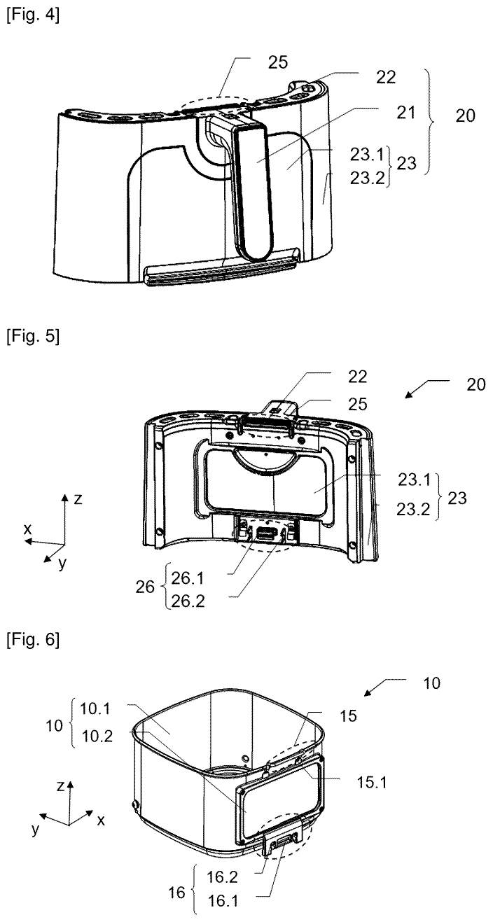

In this FIG. 3, and in FIG. 4, it can be seen that the gripping interface 20 comprises:
a gripping handle 21,
a control button 22, located in the upper part of the gripping handle 21 (along the z-axis),
a wall portion 23, comprising a transparent glass pane 23.1 and an opaque wall 23.2,
an upper gripping attachment 25, mounted on the gripping interface 20 and located in the upper part of the gripping handle 21 (along the z-axis), behind the control button 22 (along the y-axis).

In FIG. 5, it can be seen that the gripping interface 20 comprises:
the control button 22, located in the upper part of the gripping handle 21,
the wall portion 23, comprising the transparent glass pane 23.1 and the opaque wall 23.2,
the upper gripping attachment 25, mounted on the gripping interface 20,
a lower gripping attachment 26 comprising in particular a movable hook 26.1 and fixed hooks 26.2 arranged on either side of the movable hook 26.1 along the x-axis.

As shown in FIG. 3 and more specifically in FIG. 6, the cooking vat 10 itself comprises:
a body 10.1, forming a preferably metal vat,
a transparent viewing window 10.2,
an upper vat attachment 15, mounted on the cooking vat 10, arranged on an upper part of the cooking vat 10 along the z axis, and in particular comprising a support rod 15.1,
a lower vat attachment 16, mounted on the cooking vat 10, arranged on a lower part of the cooking vat 10 and comprising in particular a locking rod 16.1 and positioning recesses 16.2 arranged on either side of the locking rod 16.1 along the x axis.

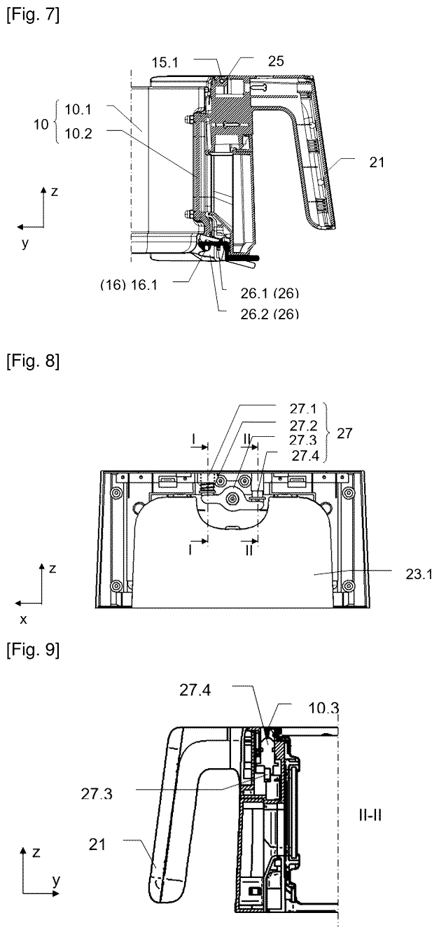

FIG. 7 shows a cross-sectional view of the cooking utensil 30 in FIG. 2, in a plane parallel to the y-z plane of the reference point in FIG. 2, to show the cooking vat 10 coupled with the gripping interface 20.

It can be seen in FIG. 7 that the upper vat attachment 15 and the upper gripping attachment 25 are engaged with each other. In particular, the upper gripping attachment 25 comprises a U-shape directed upwards along the z-axis, which holds the support rod 15.1 placed on the upper part of the cooking vat 10 along the z-axis. Thus, the weight of the cooking vat 10 is borne by the upper gripping attachment 25, which holds the support rod 15.1. The coupling of the upper gripping attachment 25 with its upwardly directed U-shape and the support rod 15.1 thus form a pivot connection between the cooking vat 10 and the gripping interface 20.

In the bottom part of FIG. 7, it can be seen that the lower gripping attachment 26 is engaged with the lower vat attachment 16. In particular, it can be seen that the fixed hooks 26.2 are engaged in the positioning recesses 16.2 (not shown in FIG. 7). Moreover, the movable hook 26.1 (in black) is lowered onto the locking rod 16.1. The movable hook 26.1 can be rotated around an axis parallel to the x-axis, as can be seen in FIG. 7, with the silhouette of the movable hook 26.1 angularly offset relative to the movable hook 26.1 in black.

As shown in FIG. 7:
the movable hook 26.1, engaged with the locking rod 16.1, prevents any rotation of the gripping interface 20 relative to the cooking vat 10;
in addition, the fixed hooks 26.2 engaged in the positioning recesses 16.2 limit the translational movement of the gripping interface 20 relative to the cooking vat 10 along the x and z axes.

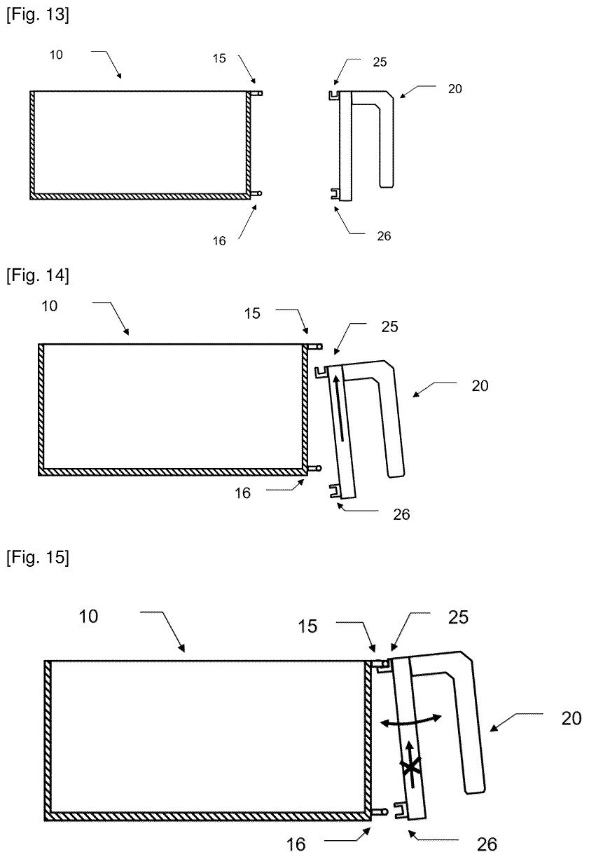

The shape of the movable hook 26.1 is configured, in particular via the slope of its friction ramp which comes into contact with the locking rod 16.1 during the coupling movement of the gripping interface 20 on the cooking vat 10, so that it latches the attachment of the gripping interface 20 onto the cooking vat 10 when the cooking, vat 10 is inserted into the inner cooking space of the food preparation appliance. In the configuration in FIG. 7, the gripping interface 20 is locked in position relative to the cooking vat 10. When the movable hook 26.1 is moved (as a result of a user action on the control button 22) and occupies the angularly offset position of its silhouette in FIG. 7, the gripping interface 20 can be moved counter-clockwise relative to the cooking vat 10, and then the upper gripping attachment 25 (and its upward-pointing U-shape) can be moved downwards to release the support rod 15.1. The coupling and release sequence will be explained in more detail with reference to FIGS. 13 to 16.

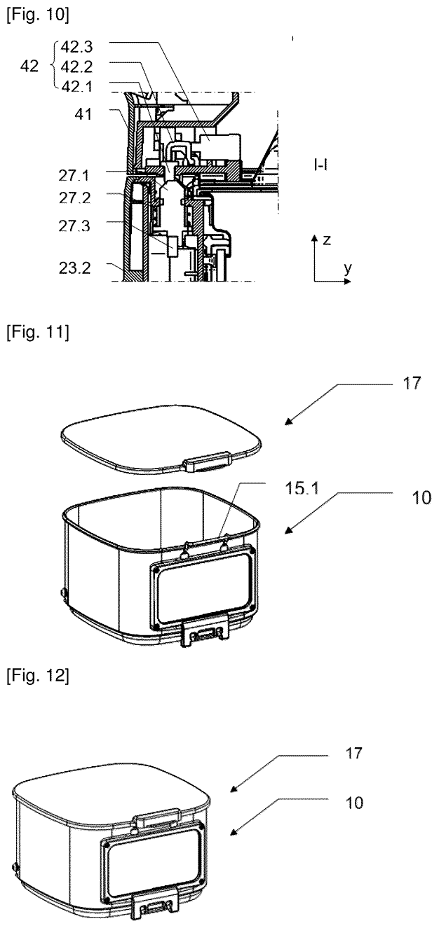

As shown in FIG. 8, the cooking utensil 30 can comprise a coupling detection device 27, comprising at least one coupling indicator 27.1 which can be moved between:
a resting position, occupied when the cooking vat 10 is uncoupled from the gripping interface 20,
an activated position (as shown in FIG. 8 or 10), occupied when the cooking vat 10 is coupled with the gripping interface 20. FIG. 8 shows a rear view of an inner part of the gripping interface 20 in FIG. 2 or 3, to clearly show the coupling detection device 27, comprising:
the coupling indicator 27.1,
a rocker arm 27.3, pivoting around a rocker axis,
a control piston 27.4, designed to be actuated by a keying member 10.3 attached to the cooking vat 10, and optionally
a return spring 27.2, designed to return the coupling indicator 27.1 downwards (along the z axis).

The return spring 27.2 is not essential, and there is no need for the coupling indicator 27.1 to occupy any position between the activated position and the resting position when the cooking vat 10 is released from the gripping interface 20.

FIG. 9 shows a cross-sectional view of the cooking utensil 30 in FIG. 8, in a cross-sectional plane II-II in FIG. 8. It can be seen that the keying member 10.3 acts on the control piston 27.4 (pushing it downwards), which in turn acts on the rocker arm 27.3.

FIG. 10 shows a cross-sectional view of the cooking utensil 30 in FIG. 8, in a cross-sectional plane I-I in FIG. 8. It can be seen that the rocker 27.3 (pushed as shown in FIG. 9 by the control piston 27.4 and the keying member 10.3) pushes the coupling control 27.1 upwards despite the recall spring 27.2. As a result, a coupling detector 42 (comprising a feeler probe 42.1, a return lever 42.2 and a detection switch 42.3), located behind a wall 41 of the housing 40, can detect that the cooking vat 10 is indeed properly coupled with the gripping interface 20.

The gripping interface 20 can have a notch on its rear panel to allow the feeler probe 42.1 to be fed through and aligned with the coupling indicator 27.1 when the cooking utensil (cooking vat 10 and gripping interface 20) is inserted into the food preparation appliance.

Such a coupling detection device 27 can be part of a safety system to detect that the cooking vat 10 is properly coupled with the gripping interface 20 before starting the food preparation appliance. In particular, the control unit of the food preparation appliance can prohibit any operation or functionality of the food preparation appliance (and in particular the activation of the heating and/or ventilation means) if the cooking vat 10 is not coupled with the gripping interface 20. In fact, if the cooking vat 10 is not coupled with the gripping interface 20 and is nevertheless installed in the housing 40, the front panel of the food preparation appliance (the wall portion 23, comprising the transparent glass pane 23.1, the opaque wall 23.2, and mounted on the gripping interface 20) will be missing and operation would not be safe.

Similarly, if the front panel of the food preparation appliance is nevertheless installed on the appliance, but the cooking vat is missing, then the control unit of the food preparation appliance can prevent the food preparation appliance from being operated at all.

Additionally, the keying member 10.3 can comprise the support rod 15.1, so that when the upper vat attachment 15 and the upper gripping attachment 25 are engaged with each other, the control piston 27.4 is then pushed downwards and, under the action of the rocker arm 27.3, the coupling indicator 27.1 is pushed upwards.

In this case, the upper gripping attachment 25 of the gripping interface 20 comprises a groove for accommodating the support rod 15.1, and the control piston 27.4, in its raised position, opens into this groove without protruding beyond the height of the gripping interface 20.

The support rod 15.1 can also be slightly off-center towards the control piston 27.4 to enable the control piston 27.4 to be actuated without interfering with the movement of the coupling indicator 27.1.

FIG. 11 shows a perspective top view of the cooking vat 10 in FIG. 2 or 3, with a lid 17 to be coupled to the cooking vat 10. FIG. 12 shows a perspective top view of the cooking vat 10 in FIG. 2 or 3, with a lid 17 coupled to the cooking vat 10. It can be seen that the lid 17 comprises a coupling portion designed to couple with the support rod 15.1, for example by elastic interlocking (clip-on). Thus, the lid 17 is held securely on the cooking vat 10.

FIG. 13 shows a schematic cross-sectional view of the cooking vat 10 and of the gripping interface 20 in FIG. 2 or 3 before coupling, in a plane parallel to the y-z plane of the reference point in FIG. 2. It should be noted and remembered that:
the upper vat attachment 15 comprises in particular a support rod 15.1 and is located in FIG. 13 opposite the upper gripping attachment 25 which comprises in particular an upwardly-pointing U-shape
the lower vat attachment 16 comprises in particular the locking rod 16.1 and is located in FIG. 13 opposite the lower gripping attachment 26 which comprises in particular a movable hook 26.1 and fixed hooks 26.2.

FIG. 14 shows the cooking vat 10 and the gripping interface 20 in FIG. 13, in a first coupling phase, in which:
the gripping interface 20 is first moved downwards, and
the upper gripping attachment 25 (which comprises in particular an upwardly-pointing U-shape) is then moved upwards to engage the support rod of the upper vat attachment 15 in the U-shape of the upper gripping attachment 25.

FIG. 15 shows the cooking vat 10 and the gripping interface 20 in FIG. 13 in a second coupling phase, in which:
the first coupling phase is completed, such that the U-shape of the upper gripping attachment 25 is holding the support rod of the upper vat attachment 15, thus ensuring a pivotal connection between the cooking vat 10 and the gripping interface 20,
no further upward movement of the upper gripping attachment 25 relative to the upper vat attachment 15 is possible,
pivoting between the cooking vat 10 and the gripping interface 20 is possible, in particular to bring the lower vat attachment 16 closer to the lower gripping attachment 26.

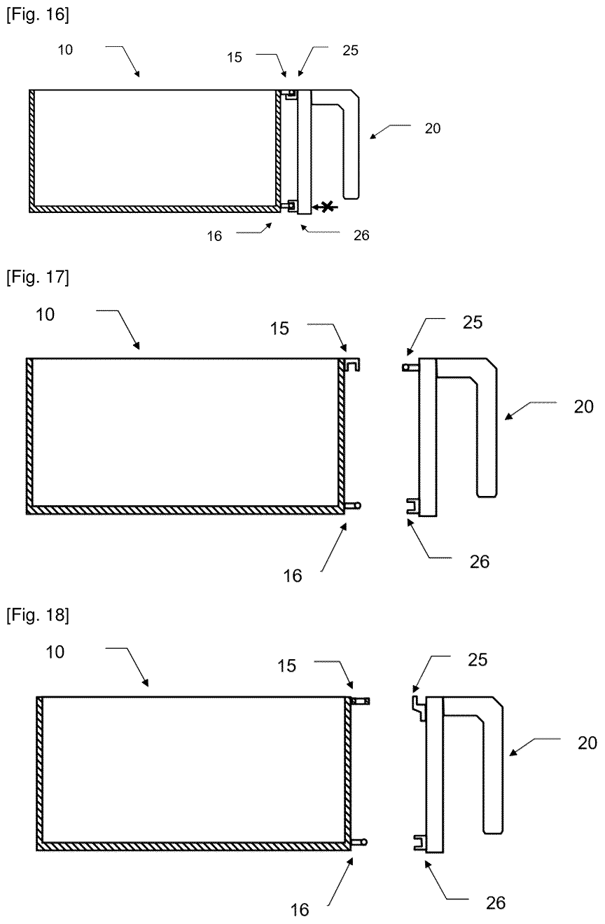

FIG. 16 shows the cooking vat 10 and the gripping interface 20 in FIG. 13, coupled together. Indeed, the second coupling phase is complete, with the lower vat attachment 16 contacting the lower gripping attachment 26. The movable hook 26.1 (shown in particular in FIG. 7) has been able to pivot and engage on the locking rod 16.1, so that no relative movement is possible between the cooking vat 10 and the gripping interface 20.

To release the cooking vat 10 and the gripping interface 20, all that is required is to actuate the control button 22 to pivot the movable hook 26.1 and be able to release the lower vat attachment 16 from the lower gripping attachment 26 by a relative rotational movement, and then move the gripping interface 20 towards the bottom of the cooking vat 10 to release the U-shape of the upper gripping attachment from the support rod of the upper vat attachment 15.

It should be noted that if the user unintentionally operates the control button 22 while normally holding the cooking utensil 30 by the gripping interface 20, the cooking vat 10 will not be released, as the weight of the cooking vat 10 itself:
forces the support rod 15.1 to remain in the U-shape of the upper gripping attachment 25, and
keeps the fixed hooks 26.2 pressed on the cooking vat 10. As a result, the cooking utensil 30 is easy to handle, the gripping interface 20 and the cooking vat 10 can be easily coupled or released, and user safety is guaranteed by eliminating the risk of inadvertent release, even if the user inadvertently presses the control button 22.

FIG. 17 shows a first variant embodiment of the cooking vat and of the gripping interface in FIG. 13, in which:
the upper vat attachment 15 comprises in particular a downwardly-pointing U-shape located in FIG. 17 opposite the upper gripping attachment 25, which in particular comprises a support rod,
as in FIG. 13, the lower vat attachment 16 comprises in particular the locking rod 16.1 and is located in FIG. 17 opposite the lower gripping attachment 26, which comprises in particular the movable hook 26.1 and the fixed hooks 26.2. Thus, as with the cooking utensil 30 in FIG. 13, the upper vat attachment 15 and the upper gripping attachment 25 in the first variant embodiment are designed to impose:
a movement to release the upper gripping attachment 25 having an uncoupling motion component directed towards the bottom of the cooking vat 10, a movement to couple the upper gripping attachment 25 having a coupling motion component directed towards the top of the cooking vat 10.

FIG. 18 shows a second variant embodiment of the cooking vat and of the gripping interface in FIG. 13, in which:
the upper vat attachment 15 comprises in particular a support ring located in FIG. 18 opposite the upper gripping attachment 25, which in particular comprises an upward-pointing finger,
as in FIG. 13, the lower vat attachment 16 comprises in particular the locking rod 16.1 and is located in FIG. 18 opposite the lower gripping attachment 26, which comprises in particular the movable hook 26.1 and the fixed hooks 26.2. Thus, as with the cooking utensil 30 in FIG. 13, the upper vat attachment 15 and the upper gripping attachment 25 in the second variant embodiment are designed to impose:
a movement to release the upper gripping attachment 25 having an uncoupling motion component directed towards the bottom of the cooking vat 10,
a movement to couple the upper gripping attachment 25 having a coupling motion component directed towards the top of the cooking vat 10.

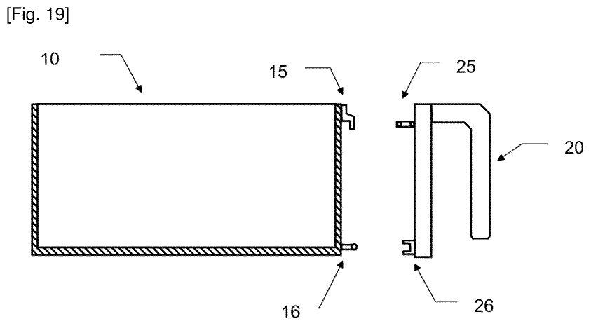

FIG. 19 shows a third variant embodiment of the cooking vat and of the gripping interface in FIG. 13, in which:
the upper vat attachment 15 comprises in particular a downward-pointing finger which is located in FIG. 19 opposite the upper gripping attachment 25, which comprises in particular a support ring,
as in FIG. 13, the lower vat attachment 16 comprises in particular the locking rod 16.1 and is located in FIG. 19 opposite the lower gripping attachment 26, which comprises in particular the movable hook 26.1 and the fixed hooks 26.2. Thus, as with the cooking utensil 30 in FIG. 13, the upper vat attachment 15 and the upper gripping attachment 25 in the third variant embodiment are designed to impose:
a movement to release the upper gripping attachment 25 having an uncoupling motion component directed towards the bottom of the cooking vat 10,
a movement to couple the upper gripping attachment 25 having a coupling motion component directed towards the top of the cooking vat 10.

### INDUSTRIAL APPLICATION

A cooking utensil according to the present invention, and the manufacture thereof, are suitable for industrial application.

It will be understood that various modifications and/or improvements that are obvious for the person skilled in the art can be made to the various embodiments of the invention described in this description without departing from the scope of the invention.

In particular, other structural embodiments can be provided to lock the cooking vat and the gripping interface: a removable pin, an elastic anti-return device, a clip, etc.

To detect the coupling, the rear side of the gripping interface can be designed to bear on an L-shaped toggle pin on the front side of the vat, thereby activating a switch on the appliance.

To detect the coupling, any kind of transmission mechanism can be provided to move the coupling indicator: a rocker arm as in the example provided, but a connecting rod, a lever, a cam, a cam track can also be provided, and the sensor attached to the housing can even be designed to directly detect the portion of the wall embedded in the gripping interface.

1. A cooking utensil for a food preparation appliance, comprising at least:
a cooking vat, configured to hold food to be prepared and configured to be held in an inner cooking space of the food preparation appliance,
a gripping interface, configured to be reversibly coupled to the cooking vat,
an attachment mechanism, comprising at least:
an upper vat protrusion coupled to an upper part of the cooking vat,
an upper gripping protrusion, coupled to the gripping interface and configured to reversibly couple with the upper vat protrusion,
wherein the upper vat protrusion and the upper gripping protrusion are configured to be:
moved to release the upper gripping protrusion from the upper vat protrusion including an uncoupling motion directed towards a bottom of the cooking vat, and/or
moved to couple the upper gripping protrusion to the upper vat protrusion including a coupling motion directed towards a top of the cooking vat.

2. The cooking utensil according to claim 1, wherein the upper vat protrusion and the upper gripping protrusion are configured to form, when coupled, a pivot connection between the cooking vat and the gripping interface.

3. The cooking utensil according to claim 1, wherein the attachment mechanism comprises:
a lower vat protrusion, coupled to a lower part of the cooking vat,
a lower gripping attachment, mounted on the gripping interface and configured to reversibly couple with the lower vat attachment.

4. The cooking utensil according to claim 3, wherein the lower vat attachment and the lower gripping attachment are configured to block a degree of rotational freedom between the cooking vat and the gripping interface when the upper vat protrusion and the upper gripping protrusion are coupled.

5. The cooking utensil according to claim 1, wherein the attachment mechanism comprises a locking mechanism configured to reversibly lock the gripping interface to the cooking vat.

6. The cooking utensil according to claim 5 wherein:
one of the lower vat attachment and the lower gripping attachment comprises a movable locking member; and
the other of the lower vat attachment and the lower gripping attachment comprises a locking counter-form configured to engage with the movable locking member.

7. The cooking utensil according to claim 1, further comprising a coupling detection device comprising at least one coupling indicator configured to be moved between:
a resting position, when the cooking vat is uncoupled from the gripping interface, and
an activated position, when the cooking vat is coupled with the gripping interface.

8. The cooking utensil according to claim 7, wherein the coupling indicator:
is arranged on a first one of the cooking vat and the gripping interface; and
is configured to be moved to the activated position by a second one of the cooking vat and of the gripping interface.

9. The cooking utensil according to claim 7, wherein the coupling detection device comprises an elastic return member configured to exert a return force on the coupling indicator towards the resting position.

10. The cooking utensil according to claim 7, wherein the coupling indicator is arranged on the gripping interface, and wherein the coupling detection device comprises a transmission member, comprising:
an input portion, configured to be actuated by the upper vat protrusion at least during an operation in which the gripping interface is coupled to the cooking vat; and,
an output portion engaged with or in contact with the coupling indicator.

11. The cooking utensil according to claim 1, wherein the gripping interface comprises a wall portion of the food preparation appliance.

12. The cooking utensil according to claim 1, comprising:
a vat lid configured to cover or close the cooking vat,
a closing mechanism for closing the lid configured to interact with the upper vat protrusion.

13. A food preparation appliance, comprising:
a cooking utensil according to claim 1,
a housing forming a cooking space for holding the cooking vat of the cooking utensil, and
a heater.

14. The food preparation appliance according to claim 13, wherein the gripping interface of the cooking utensil comprises a wall portion of the food preparation appliance, and wherein the housing has an opening configured to be closed by the wall portion of the cooking utensil, the wall portion configured to be continuous with a surface of the housing of the food preparation appliance.

15. The food preparation appliance according to claim 13,
wherein the cooking utensil further comprises a coupling detection device comprising at least one coupling indicator configured to be moved between:
a resting position, when the cooking vat is uncoupled from the gripping interface, and
an activated position, when the cooking vat is coupled with the gripping interface; and
a safety system comprising a sensor for detecting the coupling indicator at least in the activated position and configured to allow the heater to operate only when the coupling indicator is detected in the activated position.

16. The food preparation appliance according to claim 1, wherein the upper vat protrusion is a support rod.

17. The food preparation applicant according to claim 1, wherein the upper gripping protrusion forms a U-shape.

18. The food preparation appliance according to claim 6, wherein the movable locking member is one of a hook, an orifice, or a U-shape.

19. The food preparation appliance according to claim 6, wherein the locking counter-form is one of a wire, a rod, a lip, or a finger.
